(19) United States
(12) Patent Application Publication
(10) Pub. No.: US 2006/0091151 A1
(43) Pub. Date: May 4, 2006

(54) Method of delivering pre-filled carafes to the food service industry

(75) Inventor: Walter M. Lincer, Winter Haven, FL (US)

Correspondence Address: LOTT & FRIEDLAND, P.A., P.O. BOX 141098, CORAL GABLES, FL, 33114-1098, US

(73) Assignee: Citrus World, Inc.

(21) Appl. No.: 10/978,493

(22) Filed: Nov. 1, 2004

(51) Int. Cl. G01F 11/00; B67B 7/00

(52) U.S. Cl. 222/1

(57) ABSTRACT

A method of delivering pre-filled carafes to the food service industry. Specifically, the method allows for disposable or recyclable carafes to be delivered to food service locations pre-filled with beverage. The delivery method provides a more efficient and sanitary delivery system, as the carafes are delivered to the food service location pre-filled with beverage and ready to be served to the customer. Specifically, this delivery method allows for the delivery of carafes, pre-filled with lightly pasteurized, frozen juice that is not from concentrate.

### FIELD OF INVENTION

This invention relates generally to the field of delivering ready to serve beverages to the food service industry. The invention is a method of delivering pre-filled carafes to the food service industry. More particularly, the method allows for disposable or recyclable carafes to be delivered to the food service location pre-filled with beverage. The delivery method provides a more efficient delivery system, as the carafes are delivered to the food service location pre-filled with beverage and ready to be served to the customer. Specifically, this delivery method allows for the delivery of carafes, pre-filled with lightly pasteurized, frozen juice that is not from concentrate.

### BACKGROUND OF THE INVENTION

Industries in the food services and drinking places subsector prepare meals, snacks, and beverages to customer order for immediate on-premises and off-premises consumption. There is a wide range of establishments in these industries. Some provide food and drink only; while others provide various combinations of seating space, waiter/waitress services and incidental amenities, such as limited entertainment. Food service industry locations include full-service restaurants; limited-service eating places; special food services, such as food service contractors, caterers, and mobile food services; and drinking places. Food services and drink activities at hotels and motels; amusement parks, theaters, casinos, country clubs, and similar recreational facilities; and civic and social organizations are included in this subsector.

Typically, beverages delivered to the food service industry require the specific locations to handle and pour the beverage several times before it reaches the consumer. For instance, beverages can be delivered in bulk volume to the food service industry location. Then, the beverages may be transferred to a large container for access by the wait staff. When the customer orders the beverage, a single serving must then be poured from the bulk volume container. The multiple transfers of beverage increase the chances of product contamination and require a significant amount of labor.

Many food service industry locations, such as restaurants, offer carafes of beverage for customers. Most often, carafes are filled with juice and offered during the breakfast meal. Use of a carafe in a restaurant requires the restaurant wait staff to fill a carafe with the desired beverage, which is currently done from a multi serve carton or dispenser. It also requires the restaurant to purchase the carafes, store the carafes and clean the carafes. In the food service industry a huge area of concern is labor. The use of a carafe in a restaurant is labor intensive and a significant expense.

A carafe as described in U.S. Pat. No. 6,375,040 to Allanson et al. relates to a disposable storage and dispensing carafe. The carafe is specifically designed to allow for the easy transport and dispensing of a bulk volume of a hot or cold liquid in a throw-away container. More specifically, the transport of the beverages is directed to transport by the consuming public after purchase. The carafe design attempts to resolve significant safety and product quality problems encountered by transporting volumes in excess of what would be consumed by a single consumer. Additionally, the carafe design attempts to solve a significant packaging and storage challenge presented by the use of large carafes within the industry. The focus of the invention is on the design of the carafe, which includes a plastic bag disposed within the carafe for holding liquid. The patent does not discuss a method of delivering a pre-filled carafe to the food service industry for use in a restaurant.

United States Patent Application Publication No. U.S. 2003/0085232 to Leinenweber, relates to a disposable beverage container. The beverage container is designed to be readily handled by a child, and is spill-proof, sterile and can be pre-filled for use as a single-use beverage container. The beverage container can be mass-produced inexpensively, pre-filled and disposable. The design of the container specifically focuses on the ease of use by a toddler learning to drink from a cup. The patent application does not teach a method of delivering a pre-filled carafe to the food service industry for use in a restaurant.

Ornamental designs for various carafes are disclosed in U.S. Design Pats. D458,146, D458,147, D457,437 and D456,272 to Sadeghi et al. These design patents show several designs and shapes for carafes. These design patents do not teach a disposable or recyclable carafe, much less the method of delivering a pre-filled carafe to the food service industry.

One of the problems associated with current delivery methods of beverages to the food service industry is sanitation. Typically, beverages are delivered to the food service location in bulk volume and require the food service location to handle the beverage multiple times before it reaches the customer. This allows multiple chances for the beverage to be contaminated. There is a need in the art for a delivery system whereby beverage is delivered to the food service location in pre-filled carafes ready to be used and in a form immediately deliverable to the final consumer. There is also a need for an efficient beverage delivery system whereby beverage is delivered in pre-filled carafes which reduces the labor required when serving the beverage to the customer at the service location. Delivery of such a pre-filled carafe, as disclosed herein, reduces the labor required to fill and clean the carafes each time they are required to be used.

Additionally, there is a need for a method of delivering pre-filled disposable carafes to the food service industry to reduce waste. When a disposable carafe is employed, the consumer could take the remainder of the beverage with them after their meal. This would reduce waste, as the consumer could drink the beverage at a later time, rather then leaving it at the food service industry location to be disposed of. Therefore, alternate methods of delivery of disposable, pre-filled beverage carafes are needed.

Alternatively, there is a need in the art for delivery of recyclable, pre-filled carafes to the food service industry. The recyclable carafes would reduce waste and increase efficiency as they would be returned to the company of origin or delivery service on a regular basis, re-filled, and returned to the food service location. Non-recyclable carafes must be stored at the food service location and take up a considerable amount of storage space, in addition to the labor required to clean the carafes. Consequently, there is a need for recyclable, pre-filled carafes to be delivered to the food service industry.

There is also a need in the art for delivery of frozen, pre-filled carafes to the food service industry. To date, a pre-filled carafe in a frozen state has never been available for delivery to the food service industry. The delivery of a pre-filled, frozen carafe that is lightly pasteurized would benefit the food service industry and distributors by providing a beverage with an extended shelf life. An extended shelf life would enable the food service industry and distributors thereto to more efficiently manage stock.

### SUMMARY OF THE INVENTION

The present invention solves significant problems in the art by providing a method of delivering pre-filled, ready to use carafes to the food service industry. There are many advantages to such a method. The delivery method provides a more efficient delivery system, as the carafes are delivered to the restaurant pre-filled with beverage and ready to be served to the customer. The system saves on the labor required to fill and clean the carafes each time they are required to be used. The system also saves on the labor involved in serving customers. For example, in a buffet breakfast situation, the wait staff will not have to return to the table to re-fill juice glasses as the customer can re-fill their own glass from the carafe resulting in less waiting time, less server duties, and potentially a quicker turn-over of the table. The system saves the food service industry the expense of having to buy the carafes separate and apart from the beverage. The system provides a more sanitary method of beverage delivery, as the carafe is not required to be re-used and there is little chance of contamination because the beverage is not required to be transferred from the originally delivered container. The system reduces waste as the disposable carafe can be taken by the customer after the meal. Alternatively, the carafes could be made to be recyclable by the delivery service. When pre-filled carafes are delivered frozen and pasteurized with an extended shelf life, the delivery systems allows the food service industry and distributors to more efficiently manage stock.

The above and other objects of the invention are achieved in the embodiments described herein by providing a method of delivering pre-filled carafes to the food service industry. The invention consists of a method of delivering a pre-filled carafe to a food service location, said method comprising the steps of filling the carafe with a beverage, sealing the pre-filled carafe, and delivering the pre-filled carafe to the food service location. The invention also covers a method for efficiently delivering, storing and serving a pre-filled carafe to a food service location comprising the steps of filling the carafe with a beverage, sealing the pre-filled carafe, delivering the pre-filled carafe to the food service location, wherein said pre-filled carafe is delivered by a delivery service, and serving the pre-filled carafe to a customer. The invention further consists of a method of delivering a pre-filled carafe to a food service location, said method comprising the steps of receiving an order for a defined number of the pre-filled carafes from the food service location, filling the carafe with a beverage, sealing the pre-filled carafe, and delivering the ordered number of the pre-filled carafes to the food service location, wherein said pre-filled carafes are delivered by a delivery service. The delivery is accomplished by a delivery service, typically a refrigerated truck. The food service location orders the amount of pre-filled carafes that it needs for a predetermined amount of time. The carafes are then delivered to the food service location, pre-filled and either frozen or refrigerated. Once a customer orders a carafe of beverage, the food service location would serve a carafe to the customer. The pre-filled carafes may be recyclable or disposable. The disposable carafes may be kept by the consumer after their meal and used by the consumer as a convenient container for taking their remaining beverage with them. The recyclable carafes may be returned to the company of origin or delivery company on a regular basis, re-filled, and returned to the food service location.

The method of the present invention is capable of delivering fresh, refrigerated or frozen beverage. In the preferred embodiment, the beverage is juice, specifically orange juice or grapefruit juice. However, many beverages can be delivered by the delivery method. In one embodiment, the delivery is of a pre-filled, frozen carafe of juice that is not from concentrate and lightly pasteurized, which would benefit the food service industry and distributors by providing a beverage with an extended shelf life. The benefit of the product being frozen and lightly pasteurized is particularly important to the food service industry and distributors, as it provides for an extended shelf life prior to delivery to the end-user.

### BRIEF DESCRIPTION OF THE DRAWINGS

FIG. 1 is a flow diagram of the delivery method of pre-filled carafes.

FIG. 2 is a perspective view of a triangle shaped carafe to be employed in the method of delivery.

FIG. 3 is a bottom view of a triangle shaped carafe.

FIG. 4 is a perspective view of a triangle shaped carafe.

FIG. 5 is a perspective view of a round shaped carafe with a cap.

FIG. 6 is a perspective view a round shaped carafe with a cap.

### DETAILED DESCRIPTION OF THE PREFERRED EMBODIMENT

While the invention is susceptible of several embodiments, there is shown in the drawings, specific embodiments thereof, with the understanding that the present disclosure is to be considered as an exemplification of the invention and is not intended to limit the invention to the specific embodiments shown.

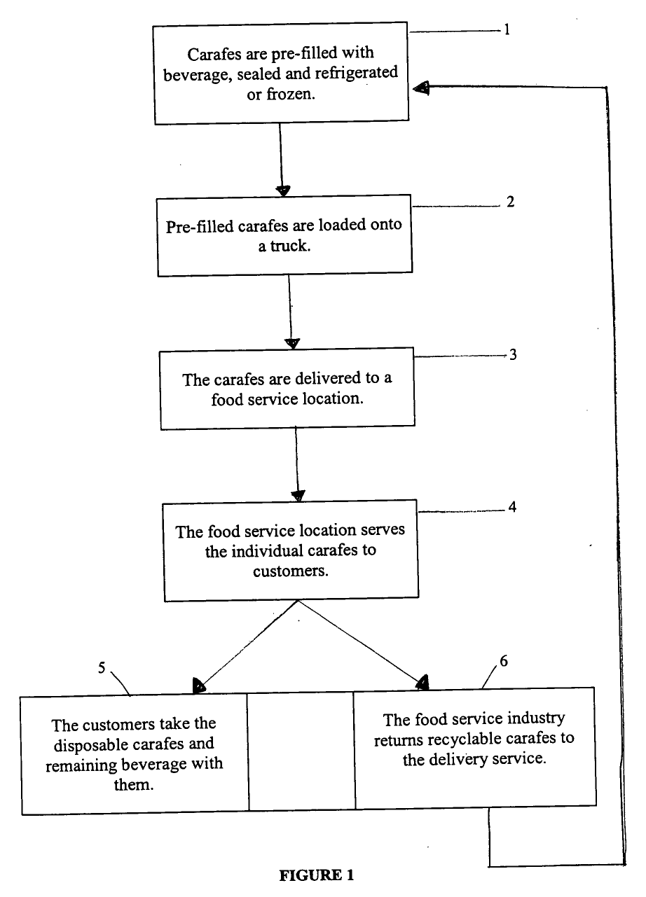

Referring initially to FIG. 1 of the drawings, in which like numerals indicate like elements throughout the several views, a flow diagram of the method of delivering pre-filled carafes is shown. Step 1 involves the carafes being filled with beverage, sealed and refrigerated or frozen. This step would also include any pasteurization or other preparation that would be required to make the beverage safe to drink. It is highly desirable that the carafe be sealed by means of a tamper proof closure. The seal on the carafe could be a plastic or foil seal or optionally the seal may be integrated into a cap on the carafe. The carafe should remain hermetically sealed until immediately prior to the beverage from therein being served to the customer or the carafe being delivered to the table. The carafe may optionally be labeled identifying the beverage brand.

The pre-filled carafes are then loaded onto a delivery truck in step 2 for delivery by a delivery service. The distribution chain for the product generally involves a broad-line food service distributor. Typically, the distributor considers a refrigerated product an obstacle due to the shorter shelf life. In the preferred embodiment, the pre-filled carafe is frozen, because a frozen, not from concentrate, pasteurized, pre-filled carafe offers the distributor the ability to work with a frozen product with a shelf life of one year or more. Such a shelf life allows the distributor to manage its stock more efficiently and therefore the delivery services to the food service industry are more efficient. Additionally, the benefit of a frozen product is particularly important to the international markets as it provides a longer shelf life prior to delivery to the end user combined with a premium quality beverage that is not currently available to those markets. The delivery truck, which delivers the pre-filled carafes, is refrigerated to a sufficient temperature to allow the beverage to remain either frozen or cold. Alternatively, the beverage could be shipped by any known delivery service; for example, the carafes could be shipped in insulated boxes to the desired food service location. Some beverages may not need to be refrigerated during transport. Therefore it is understood that many potential delivery methods could be used for delivering pre-filled carafes.

In step 3 the carafes are delivered to a food service location. This may be a full-service restaurant; limited-service eating place; special food services, such as food service contractors, caterers, and mobile food services; or any facility where beverages are sold. The carafes are then stored by the food service industry location in either a freezer, refrigerator, or at room temperature, depending upon the beverage requirements. Step 4 calls for the food service location to serve the individual carafes to the customer. Some beverages, for example juices, may require the food service location to shake or agitate the carafe before serving. Additionally, the seal and/or cap of the carafe should be removed prior to serving the beverage. Instead of the customer purchasing a single glass of juice, they are now able to purchase the equivalent of four glasses of juice with savings to the customer as well as to the food service industry location. The savings to the restaurant are seen in labor savings as well as handling of the packaging when compared to traditional re-useable carafes. The system also saves on the labor involved in serving customers. For example, in a buffet breakfast situation, the wait staff will not have to return to the table to re-fill juice glasses as the customer can re-fill their own glass from the carafe resulting in less waiting time, less server duties, and potentially a quicker turn-over of the table. If the carafe is disposable, the consumer can take the remaining beverage and carafe with them at the end of their meal, as shown in step 5. A disposable carafe may include a re-usable cap portion for ease of transport by the consumer.

If the carafe is recyclable, the food service industry location will return the recyclable carafe to the delivery service after the beverage contained therein has been consumed, as shown in step 6. The recyclable carafe can then be cleaned, sanitized and re-filled with beverage and returned to the food service location. This delivery method reduces the labor at the food service location required to wash and re-fill the carafes. This delivery method also reduces the chances of contamination. Optionally, the food service location could re-fill the recyclable carafes.

In the preferred embodiment, the method of delivery is used to deliver ready to serve, disposable carafes pre-filled with juice to food service industry locations. Predominately, juice is served from a carafe at a food service industry location that serves breakfast; however, carafes can be used for a variety of beverages and accompany any meal. The entire table can consume beverage served by such a carafe.

The delivery method of the present invention can be used to deliver frozen or refrigerated pre-filled carafes containing juice. The carafes are filled at the manufacturing plant with fresh juice, then pasteurized and sealed. The pre-filled, disposable carafes are kept either frozen or refrigerated until and during shipment to the food service industry location. The manufacturer, supplier, wholesaler or the company responsible for taking orders from the food service location would receive orders for the amount of pre-filled carafes that the location requires over a predetermined amount of time. For example, the deliveries could be scheduled weekly, bi-weekly, monthly or any other appropriate schedule. The ordered amount of pre-filled carafes are then loaded onto a delivery truck, which is capable of carrying frozen or refrigerated products, depending upon the requirements of the beverage being shipped.

The pre-filled, disposable carafes are then delivered to the food service location. The pre-filled carafes are stored at the food service location until ordered by a consumer. Depending upon whether the food service location has ordered frozen or refrigerated juice, the carafes are either frozen or refrigerated. When ordered by a customer, the pre-filled carafe is shaken and the seal is removed. The carafe is then delivered to the customer. After the customer's meal, the customer can take the disposable carafe with them, including any juice remaining in the carafe. This reduces the labor efforts of the restaurant in cleaning the carafe. It also saves on the labor involved in serving customers. The wait staff will not have to return to the table to re-fill juice glasses as the customer can re-fill their own glass from the carafe resulting in less waiting time, less server duties, and potentially a quicker turn-over of the table. It reduces the waste of left over juice remaining in the carafe. It also reduces the amount of space taken up by the storage of the carafe at the food service location. Moreover, the consumer is receiving a fresh, sealed juice carafe, without risk of contamination from the handling and serving process.

In an alternate embodiment, the pre-filled carafe being delivered to the food service location is a recyclable carafe. The method of delivery is the same for a recyclable carafe as is described above for a disposable carafe, except that the customer does not keep the carafe. The food service location keeps the carafe and it is sent back to the manufacturing plant via the delivery service. At the pre-determined scheduled delivery time, the delivery service picks up the empty carafes and replenishes the stock of the inventory of the food service location with pre-filled carafes. The empty recyclable carafes are then returned to the manufacturing plant, cleaned, sanitized and re-filled with beverage. Recyclable carafes can be made of glass, plastic or other appropriate material. The recyclable plastic carafes may be re-used or recycled with other plastic products.

In another embodiment, the carafe is a pre-filled, one-liter carafe filled with lightly pasteurized, not from concentrate juice and is frozen. The frozen carafe is delivered to the food service industry as discussed in previous examples.

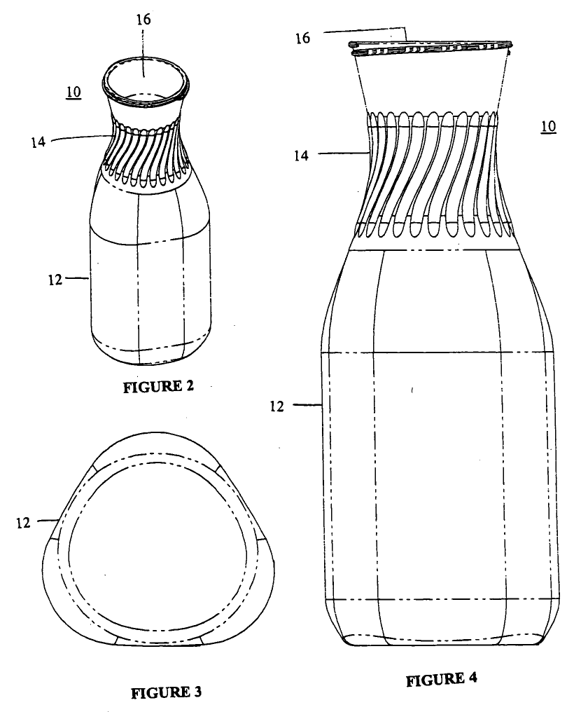

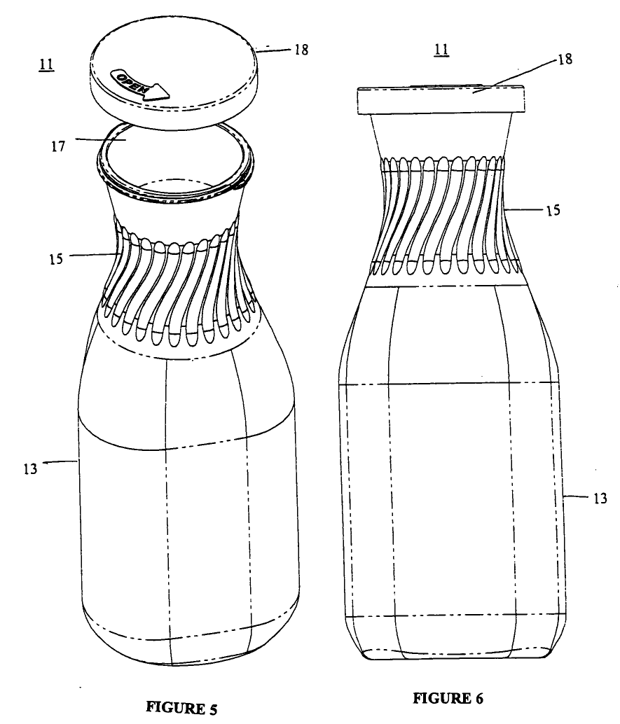

FIGS. 2, 3, 4, 5 and 6 are embodiments of carafes 10 and 11 that may be used with the above described methods of delivery. FIGS. 2, 3 and 4 show carafe 10 with a triangle shaped body 12, while FIGS. 5 and 6 show carafe 11 with a round shaped body 13. The neck 14 and 15 of each respective carafe 10 and 11 is narrower than the body 12 and 13. Each carafe 10 and 11 includes a mouth 16 and 17 or opening from which liquid is poured. Both carafes 10 and 11 can be made of polyvinylchloride, various other plastics, glass, or other suitable materials. The surface of the body 12 and 13 portion of the carafes 10 and 11 can be labeled and any area of the surface of the carafes 10 and 11 may contain decorative features. The carafes 10 and 11 are both designed to receive a cap 18 or other suitable device capable of sealing the contents.

Accordingly, it will be understood that the preferred embodiment of the present invention has been disclosed by way of example and that other modifications and alterations may occur to those skilled in the art without departing from the scope and spirit of the appended claims.

What is claimed is:

1. A method of delivering a pre-filled carafe to a food service location, said method comprising the steps of:
(a) filling the carafe with a beverage,
(b) sealing the pre-filled carafe, and
(c) delivering the pre-filled carafe to the food service location.

2. The method of claim 1 wherein said pre-filled carafe is delivered frozen.

3. The method of claim 1 wherein said pre-filled carafe is delivered refrigerated.

4. The method of claim 1 wherein said delivering step further includes delivering by a delivery service.

5. The method of claim 1 wherein said carafe is disposable.

6. The method of claim 1 wherein said carafe is recyclable.

7. The method of claim 1 wherein said beverage is juice.

8. The method of claim 1 wherein said beverage is orange juice.

9. The method of claim 6 further including the step of:
(a) recycling the carafe by the food service location returning the carafe to a delivery service,
(b) refilling the carafe, and
(c) returning the carafe to the food service location.

10. The method of claim 1 further including the step of:
serving the pre-filled carafe to a customer.

11. The method of claim 10 wherein said serving step reduces the labor required by a wait staff by reducing the wait staff's trips to the customer's table.

12. A method for efficiently delivering, storing and serving a pre-filled carafe to a food service location comprising the steps of:
(a) filling the carafe with a beverage,
(b) sealing the pre-filled carafe,
(c) delivering the pre-filled carafe to the food service location, wherein said pre-filled carafe is delivered by a delivery service, and
(d) serving the pre-filled carafe to a customer.

13. The method of claim 12 wherein said pre-filled carafe is delivered frozen.

14. The method of claim 12 wherein said pre-filled carafe is delivered refrigerated.

15. The method of claim 12 wherein said carafe is disposable.

16. The method of claim 12 wherein said carafe is recyclable.

17. The method of claim 12 wherein said beverage is juice.

18. The method of claim 12 wherein said beverage is orange juice.

19. The method of claim 12 further including the step of:
(a) recycling the carafe by the food service location returning the carafe to the delivery service,
(b) refilling the carafe, and
(c) returning a pre-filled carafe to the food service location.

20. The method of claim 12 wherein said serving step reduces the labor required by a wait staff by reducing the wait staff's trips to the customer's table.

21. A method of delivering a pre-filled carafe to a food service location, said method comprising the steps of:
(a) receiving an order for a defined number of the pre-filled carafes from the food service location,
(b) filling the carafe with a beverage,
(c) sealing the pre-filled carafe, and
(d) delivering the ordered number of the pre-filled carafes to the food service location, wherein said pre-filled carafes are delivered by a delivery service.

22. The method of claim 21 wherein said pre-filled carafe is delivered frozen.

23. The method of claim 21 wherein said pre-filled carafe is delivered refrigerated.

24. The method of claim 21 wherein said carafe is disposable.

25. The method of claim 21 wherein said carafe is recyclable.

26. The method of claim 21 wherein said beverage is juice.

27. The method of claim 21 wherein said beverage is orange juice.

28. The method of claim 25 further including the step of:
(a) recycling the carafe by the food service location returning the carafe to the delivery service,
(b) refilling the carafe, and
(c) returning the pre-filled carafe to the food service location.

29. The method of claim 21 further including the step of serving the pre-filled carafe to a customer.

30. The method of claim 29 wherein said serving step reduces the labor required by a wait staff by reducing the wait staff's trips to the customer's table.
